(19) United States
(12) Patent Application Publication
(10) Pub. No.: US 2025/0198849 A1
(43) Pub. Date: Jun. 19, 2025

(54) METHODS AND APPARATUS TO CALIBRATE THERMAL SENSORS

(71) Applicant: The Boeing Company, Arlington, VA (US)

(72) Inventors: Lori Sue Perry, O'Fallon, MO (US); Travis Taylor Marshall, St. Peters, MO (US); Jeffery Thomas Murphy, Troy, MO (US); David Kendall Conradi, St. Louis, MO (US); Dane Stewart Jackson, Collinsville, IL (US); Brian Andrew Gunther, St. Louis, MO (US)

(21) Appl. No.: 18/545,632

(22) Filed: Dec. 19, 2023

(51) Int. Cl. G01J 5/80

(52) U.S. Cl. CPC G01J 5/80

(57) ABSTRACT

Methods and apparatus to calibrate thermal sensors are disclosed. A disclosed apparatus to calibrate a sensor includes a shroud defining a sensor aperture and a chamber, a blackbody target disposed within the chamber, and a fluid inlet fluidly coupled to the blackbody target, the fluid inlet to receive heat transfer fluid for calibration of the sensor.

### FIELD OF THE DISCLOSURE

This disclosure relates generally to sensor calibration and, more particularly, to methods and apparatus to calibrate thermal sensors.

### BACKGROUND

In recent years, calibration of installed thermal sensors, such as infrared sensors, in their operational environments has been largely unavailable and impractical. In particular, these thermal sensors are typically installed on buildings, towers, vehicles, or production facilities where access or removal of such sensors is not feasible (e.g., due to downtime or complex/embedded installations). Further, sensor enclosure geometry and/or window effects may necessitate in-situ calibration. Generally, commercially available blackbody targets used for calibration are not portable and have a limited lower scene temperature range of −40° Celsius (C), which can be insufficient for certain applications.

### SUMMARY

An example apparatus to calibrate a sensor includes a shroud defining a sensor aperture and a chamber, a blackbody target disposed within the chamber, and a fluid inlet fluidly coupled to the blackbody target, the fluid inlet to receive heat transfer fluid for calibration of the sensor.

An example system includes a cryogenic fluid source, a chiller, and a sensor testing target including a shroud defining a sensor aperture and a chamber, the shroud including a fluid inlet fluidly coupled to the cryogenic fluid source to receive cryogenic fluid to cool or heat an internal surface of the chamber, and a blackbody target disposed within the chamber, at least one internal channel of the blackbody target fluidly coupled to the chiller to receive heat transfer fluid therefrom.

An example method of calibrating a sensor includes aligning a shroud to the sensor to cause a blackbody target of the shroud to face the sensor, the shroud defining a sensor aperture and a chamber with the blackbody target disposed therein, providing cryogenic fluid to at least one of the blackbody target or the shroud, and obtaining sensor measurements from the sensor for calibration thereof.

### BRIEF DESCRIPTION OF THE DRAWINGS

FIG. 1 depicts an example thermal sensor calibration system in accordance with teachings of this disclosure.

FIG. 2 depicts another example thermal sensor calibration system in accordance with teachings of this disclosure.

FIG. 3 depicts an example thermal sensor calibration device in accordance with teachings of this disclosure.

FIG. 4 is a cutaway cross-sectional view of the example thermal sensor calibration device shown in FIGS. 1-3.

FIG. 5 is a block diagram of an example calibration architecture in accordance with teachings of this disclosure.

FIGS. 6 and 7 are flowcharts representative of an example method in accordance with teachings of this disclosure.

FIG. 8 is a detailed view of an example blackbody target that can be implemented in examples disclosed herein.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Methods and apparatus to calibrate thermal sensors are disclosed. Typically, accurate calibration of thermal sensors, such as infrared sensors mounted to vehicles or stationary structures, is not available in the field (or in working environments) for numerous reasons, including a lack of portability/availability of blackbody targets. Existing cryogenic implementations (e.g., liquid-cooled plates, waterfall vapor cycle systems, etc.) and thermoelectric coolers (e.g., Peltier coolers) utilized as reference devices do not typically enable a range of temperatures necessitated to accurately calibrate a thermal sensor. Further, these existing implementations do not provide a suitably large calibration target with a uniform temperature to calibrate the thermal sensor. Existing implementations often necessitate relatively large and heavy cooling systems for use with an integral or remote target surface.

In known implementations, environmental exposure can cause target surface thermal variation, as well as moisture and/or ice accretion, when a target is cooled to certain calibration temperatures and/or ranges. Some known implementations utilize vacuum chambers to reduce and/or mitigate thermal loss and ice accretion, but such chambers are not generally feasible in locations other than a controlled lab facility. Existing calibration devices often include relatively small and/or planar surfaces (e.g., less than 1-2 square inches) across which energy is relatively unevenly absorbed/distributed, thereby resulting in an unsuitable target for calibration. Further, by utilizing a relatively small target area, these known calibration devices can necessitate a relatively short focal length with respect to a calibration target, which may not be practical or possible. Accordingly, known calibration devices do not cover a sensor field of view and, thus, can reduce a calibration accuracy and range thereof.

Examples disclosed herein enable a relatively portable and accurate calibration solution for thermal sensors including, but not limited to, infrared thermal sensors. Examples disclosed herein can also mitigate the effects of moisture and ice accretion when cooling sensor temperatures significantly. According to some examples disclosed herein, a liquid loop provides heat transfer fluid, which may be a cryogenic fluid, to a blackbody target (e.g., a metal blackbody target) such that the heat transfer fluid flows internal to the blackbody target along a double reversing nested spiral pathway. In particular, the blackbody target is placed within a shroud that at least partially encompasses (e.g., fully encompasses and/or covers) a field of view of a thermal sensor. According to some examples disclosed herein, the blackbody target is sized and geometrically located/positioned to produce a relatively even temperature distribution (e.g., sized based on thermal properties and/or requirements) for relatively accurate calibration of the thermal sensor. In some examples, the blackbody target is machined and/or 3D printed.

According to some examples disclosed herein, target face shaping is utilized to facilitate control of a temperature distribution across a blackbody target. In particular, several target face contour designs were developed and studied across a wide spectrum to result in example advantageous topography disclosed herein. Accordingly, examples disclosed herein can be utilized to very effectively reduce (e.g., minimize) energy return to a sensor calibration chamber. Further, in conjunction with the target shape/geometry, complimentary coatings can be applied to further increase an emissivity of a target face.

As mentioned above, examples disclosed herein utilize a shroud (e.g., an environmental shroud) to be placed against and/or proximate the thermal sensor. The shroud defines a chamber and/or a relatively enclosed environment between the sensor and blackbody target. Accordingly, the temperature and moisture of the chamber of the shroud is controlled. According to examples disclosed herein, controlling the temperature and moisture of the chamber of the shroud is achieved by implementing a cryogenic fluid system (e.g., a liquid nitrogen system, etc.) that actively cools the shroud wall with an integrated moisture anode to draw out and contain any moisture in the chamber. In particular, regulated liquid nitrogen or other cryogenic fluid can be routed through an integral shroud manifold to cool the aforementioned chamber and locally accrete moisture onto an internal shroud wall. In turn, the liquid nitrogen can warm to a gaseous state and then enter the shroud chamber, thereby further drying the volume of the chamber prior to exiting the shroud via an outlet and/or an exhaust port.

As used herein, the term “cryogenic fluid” refers to a fluid that can remain a liquid at relatively cool temperatures of cooler than −100° Celsius (C). Accordingly, the term “cryogenic fluid” can refer to a fluid in a gaseous or liquid state. As used herein, the term “blackbody” refers to a body and/or object that absorbs nearly all incident infrared energy.

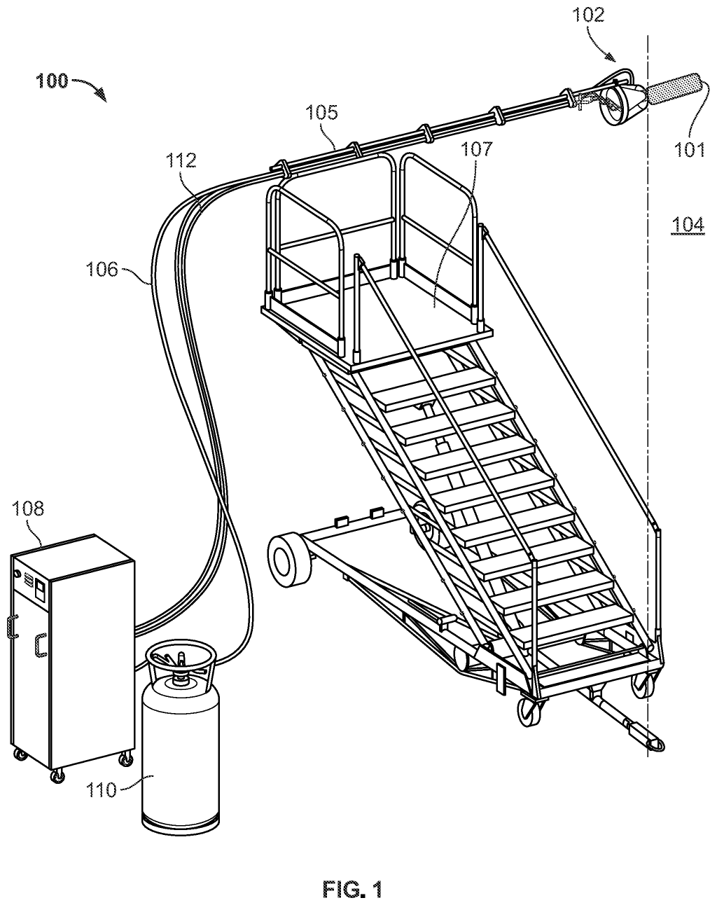

FIG. 1 depicts an example thermal sensor calibration system 100 in accordance with teachings of this disclosure. The example thermal sensor calibration system 100 is implemented to calibrate a thermal sensor 101, which is an infrared thermal sensor in this example. However, the thermal sensor 101 may be any other appropriate type of thermal sensor or temperature-based sensor. The example thermal sensor calibration system 100 includes a thermal sensor calibration device (e.g., a thermal calibration target, a sensing portion, a calibration target, a movable test assembly, a sensor testing target, etc.) 102 that is coupled and/or mounted to a structure/vehicle 104, a support 105, a cryogenic fluid line 106, a chiller 108, a support platform 107, and a cryogenic fluid source 110. In this example, the chiller 108 is fluidly coupled to chiller lines 112, which are implemented as heat transfer fluid lines in this example.

To calibrate the sensor 101, which may be part of a vehicle (e.g., an aircraft, an unmanned aerial vehicle (UAV), etc.), the thermal sensor calibration device 102 is placed against (e.g., mounted to) a surface of the structure/vehicle 104 by moving the thermal sensor calibration device 102 with the support 105. In particular, an operator standing on the aforementioned support platform 107 moves the thermal sensor calibration device 102 and aims/holds the thermal sensor calibration device 102 via the support 105. The thermal sensor calibration device 102 may be centered relative to the thermal sensor 101 when positioned relative to the thermal sensor 101 (e.g., based on indexing features of the thermal sensor 101 or a component proximate the sensor 101). According to examples disclosed herein, a field of view of the thermal sensor 101 is at least partially encompassed (e.g., fully encompassed) by an internal volume of the thermal sensor calibration device 102. In this example, the cryogenic fluid source 110 provides cryogenic fluid to the thermal sensor calibration device 102 and the chiller 108. In turn, the cryogenic fluid from the cryogenic fluid source 110 and the chiller 108 cools components, surfaces and/or portions of the thermal sensor calibration device 102, thereby causing the thermal sensor calibration device 102 to behave similar to a blackbody. As a result, the thermal sensor 101 can accurately calibrate the thermal sensor 101 at relatively low temperature ranges without necessitating a laboratory environment/equipment. Accordingly, examples disclosed herein can save time, resources and costs by enabling accurate thermal calibration at an operational site or a support/maintenance area (e.g., a landing field for an aircraft, an aircraft hangar, an outdoor area, etc.).

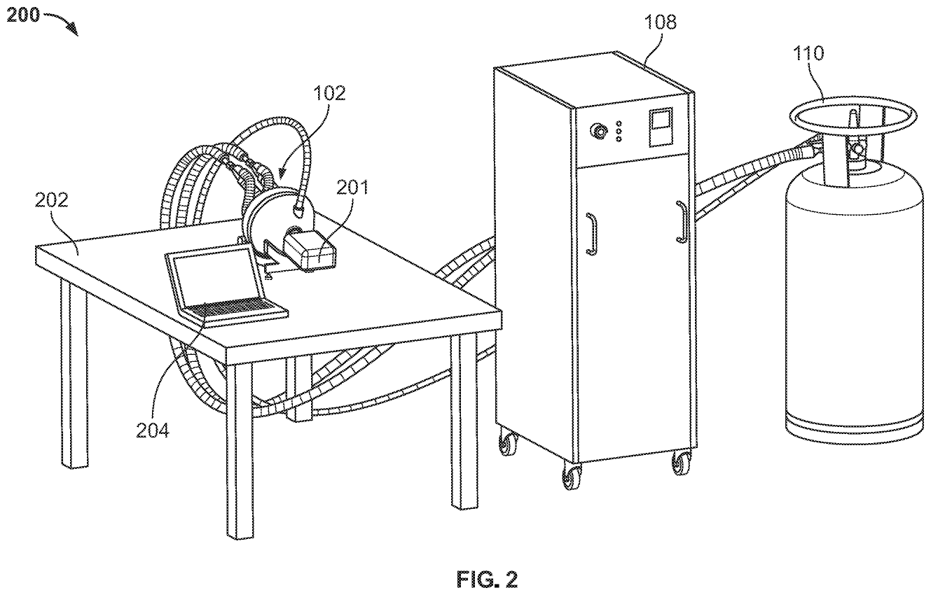

FIG. 2 depicts another example thermal sensor calibration system 200 in accordance with teachings of this disclosure. The example thermal sensor calibration system 200 can calibrate a sensor 201 on a table 202 or other surface by utilizing a computing system 204. The example thermal sensor calibration system 200 includes the thermal sensor calibration device 102, the chiller 108 and the cryogenic fluid source 110. The thermal sensor calibration system 200 is similar to the thermal sensor calibration system 100 shown in FIG. 1, but does not include the support 105 or the support platform 107 (shown in FIG. 1). In particular, FIG. 2 depicts a highly portable and convenient example tabletop/desktop implementation.

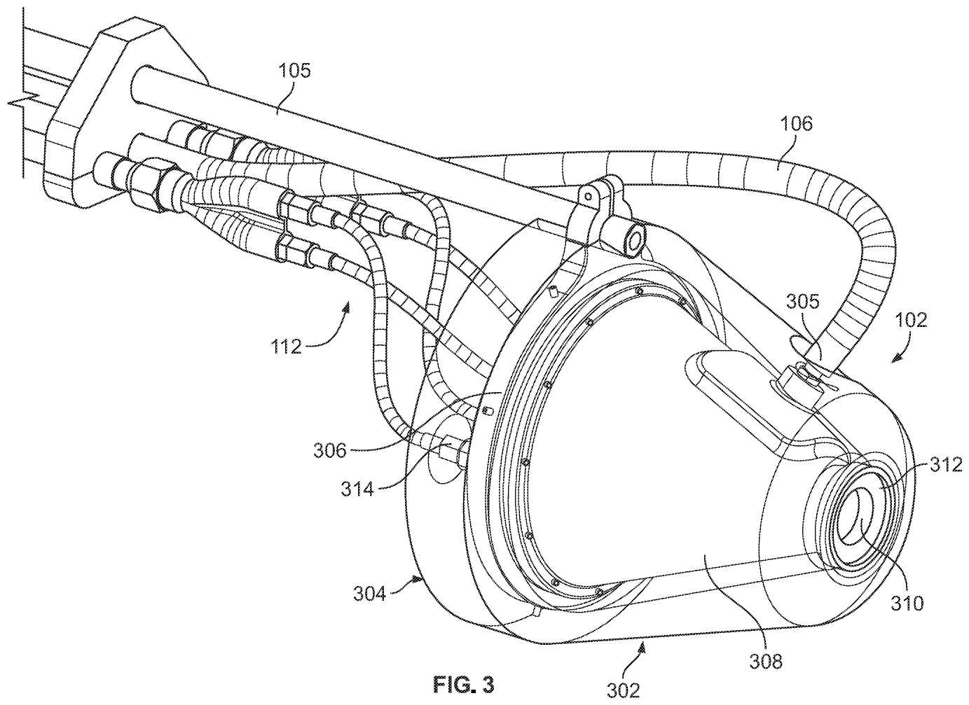

FIG. 3 depicts the example thermal sensor calibration device 102 in accordance with teachings of this disclosure. In the illustrated example of FIG. 3, the thermal sensor calibration device 102 is attached and/or mounted to the support 105. The thermal sensor calibration device 102 of the illustrated example includes a shroud (e.g., a housing) 302, which has a converging shape (e.g., is cone-shaped), a base 304, a cryogenic fluid inlet (e.g., a cryogenic fluid line) 305 and a blackbody target 306. In this example, the blackbody target 306 is enclosed and/or at least partially surrounded by an internal sub-structure (e.g., an internal frame, an internal layer, etc.) 308 of the shroud 302. Further, the shroud 302 includes an aperture 310 and an indexing surface 312. In operation, the internal sub-structure 308 of the shroud 302 is supplied with cryogenic fluid from the cryogenic fluid line 106 via the cryogenic fluid inlet 305 to reduce a presence of ice and/or moisture along a field of view between the thermal sensor and the blackbody target 306. Additionally, the chiller lines 112 are coupled to (e.g., fluidly coupled to, releasably coupled to, etc.) the base 304 and/or the blackbody target 306 via a fluid inlet 314.

To contact and/or engage a surface and/or component at least partially surrounding a thermal sensor, the example indexing surface 312 is aligned to encompass a field of view of a thermal sensor (e.g., an external surface of an aircraft surrounding the thermal sensor). For example, the aperture 310 is generally aligned to a center of a field of view of the thermal sensor (e.g., concentric with a center of the thermal sensor) and the indexing surface 312 is placed against a surface of a component and/or surface at least partially surrounding the thermal sensor. In some examples, the indexing surface 312 is placed onto a surface (e.g., an exterior surface of an aircraft) to at least partially surround the thermal sensor. Additionally or alternatively, the indexing surface 312 is pressed and/or compressed against the surface surrounding (e.g., laterally surrounding) the thermal sensor. Additionally or alternatively, the thermal sensor is at least partially surrounded by and/or inserted into the aperture 310.

In some examples, the shroud 302 is at least partially composed of a polymer (e.g., a thermoset polymer, a polymer material, etc.). However, any other materials can be implemented instead. In some examples, the shroud 302 includes insulative materials and/or layers. Additionally or alternatively, the shroud 302 is 3D printed.

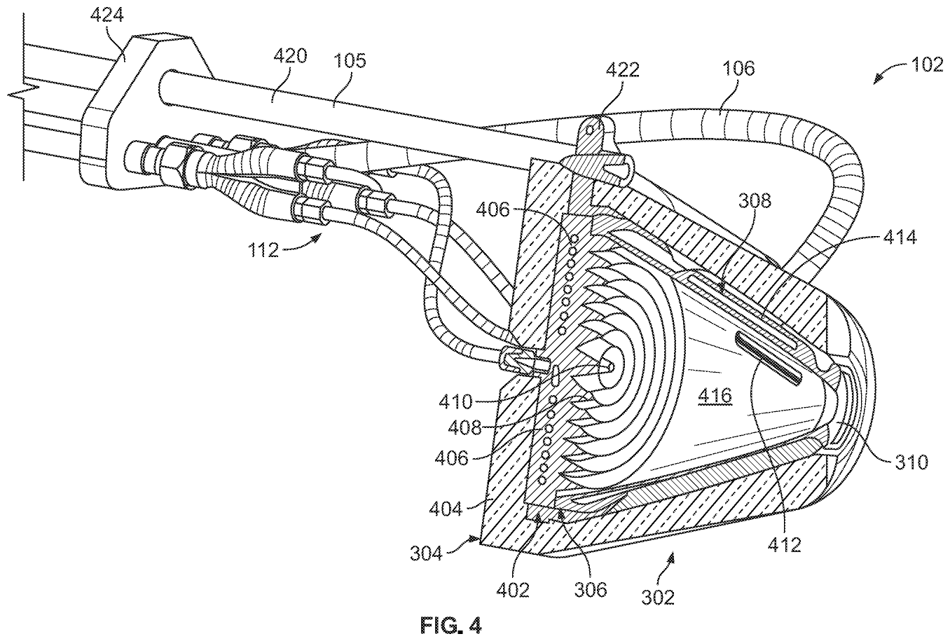

FIG. 4 is a cutaway cross-sectional view of the example thermal sensor calibration device 102 of FIGS. 1-3 that is implemented to calibrate a thermal sensor. In the illustrated example of FIG. 4, the base 304 is shown supporting and/or mounting the blackbody target 306. In this example, the blackbody target 306 includes a base 402, which is supported and/or mounted by a wall 404 of the shroud 302, and includes nested spiral liquid loops 406 with internal channels extending and/or routed through the blackbody target 306 and/or the base 402. Further, the blackbody target 306 includes a ring pattern (e.g., a ring extrusion pattern, a concentric ring pattern) 408 extending from the base 402. In particular, the example ring pattern 408 includes concentric rings that extend and/or protrude from a surface of the base 402 (e.g., with a converging shape) to define a target face shaping topography for calibration of the thermal sensor. In the illustrated example of FIG. 4, the ring pattern 408 includes a center protrusion (e.g., a center cone) 410.

To maintain the blackbody target 306 at a relatively low temperature for calibration of a thermal sensor, the fluid lines 112 provide heat transfer fluid, which may include cryogenic fluid, to the blackbody target 306 and the cryogenic fluid line 106 provides cryogenic fluid to at least a portion of the shroud 302. In the illustrated example of FIG. 4, the blackbody target 306 is provided with the heat transfer fluid via the fluid lines 112 and returns the heat transfer fluid to the fluid lines 112 once the heat transfer fluid has circulated through the nested spiral loops 406. In this example, the cryogenic fluid line 106 provides the cryogenic fluid to the shroud 302 and, in turn, to an example aperture 412 via a distribution manifold (e.g., an anode) 414 that is defined by the internal sub-structure 308. In this example, the cryogenic fluid enters the distribution manifold 414 that at least partially surrounds a chamber (e.g., a housing chamber, a cavity, an internal cavity, etc.) 416 to cool the chamber 416 and locally accrete moisture onto at least one internal wall and/or surface of the chamber 416. Further, the aperture 412 is in fluid communication with the chamber 416. In turn, the cryogenic fluid can warm to a gaseous state in the chamber 416, thereby further drying the volume of the chamber 416 prior to exiting the shroud 302 via the aperture 310 and/or an outlet/exhaust port (not shown). In other words, the resultant gas corresponding to the cryogenic fluid can remove moisture from the chamber 416. According to some examples disclosed herein, the blackbody target 306 and/or the shroud 302 are cooled to a range of approximately −130° Fahrenheit (F) to +105° F. with a tolerance of approximately ±1/2°. However, any other appropriate temperature range(s) can be implemented instead. In some examples, the shroud 302 includes insulative materials and/or layers.

In this example, the shroud 302 and, in turn, the chamber 416 are generally cone-shaped (due to the chamber 416 being defined by the shroud 302) such that an apex and/or converging end/portion of the shroud 302 defines and/or includes the aperture 310. In some examples, the shroud 302 includes insulation (e.g., insulative material, an insulation layer, etc.). The shroud 302 can be generally cone-shaped to correspond to a viewing angle of the thermal sensor. As used herein, the term “apex” refers to a portion of the shroud 302 having the smallest cross-sectional profile.

In some examples, the base 402 is carried and supported with the support 105. In some such examples, the support 105 includes a pole (e.g., a pole support) 420 extending between a flange 422 and a base plate 424. In this example, the pole 420 rigidly supports the thermal sensor calibration device 102. In other examples, the pole 420 and/or the base plate 424 is flexible and/or may be articulated for increased maneuverability and adaptability. Further, the example support 105 can also align and/or carry the cryogenic fluid line 106 and the fluid lines 112.

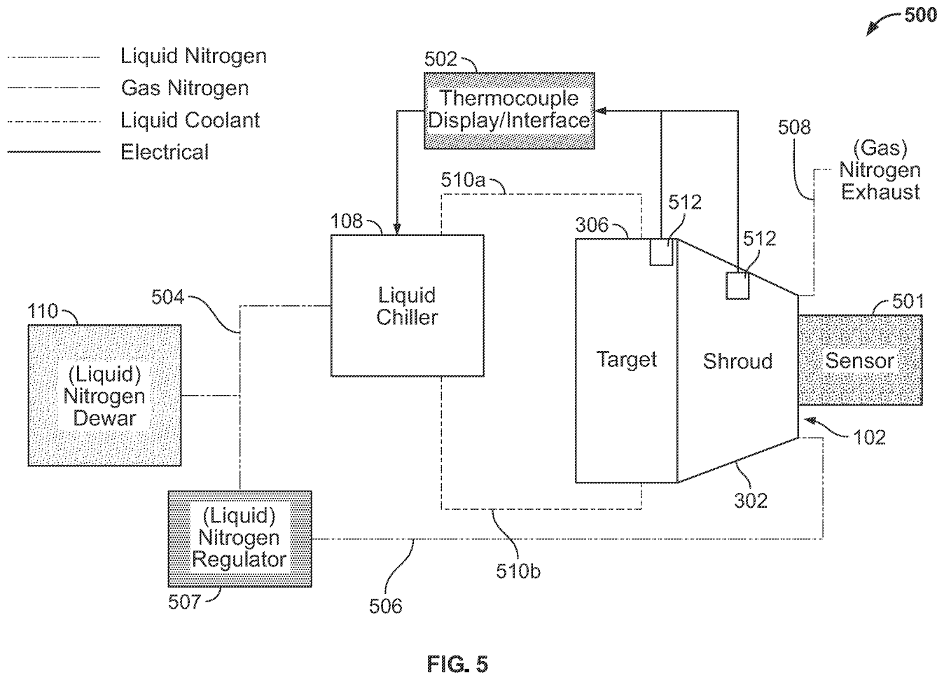

FIG. 5 is a block diagram of an example calibration architecture 500 in accordance with teachings of this disclosure. The example calibration architecture 500 may be implemented in the example thermal sensor calibration system 100 of FIG. 1, or the example thermal sensor calibration system 200 of FIG. 2. In the illustrated example of FIG. 5, the thermal sensor calibration device 102 is placed proximate (e.g., in a field of view of) a thermal sensor 501 for calibration thereof. In some examples, the thermal sensor calibration device 102 at least partially surrounds (e.g., at least partially laterally surrounds) a portion of the thermal sensor 501. In some examples, a thermocouple display/interface 502 is implemented for temperature control and/or adjustment of cryogenic fluid and/or heat transfer fluid distributed to the thermal sensor calibration device 102. In this example, the liquid chiller 108 is provided with cryogenic fluid, such as liquid nitrogen for example, from the cryogenic fluid source 110 via a distribution line 504. However, any other type of cryogenic fluid can be implemented instead, including, but not limited to methane, helium, hydrogen, argon, and carbon monoxide, etc.

To cool a temperature of the shroud 302, cryogenic fluid is provided thereto via a distribution line 506 and/or a fluid regulator 507. In this example, utilization of the cryogenic fluid in the shroud 302 enables cooling of the shroud 302 for effective calibration of the thermal sensor 501 while accretion of ice and/or fluid from within the shroud 302 can be localized at internal surfaces of the shroud 302, thereby maintaining a relatively clear field of view between the thermal sensor 501 and the blackbody target 306. In this example, gas from the cryogenic fluid (e.g., nitrogen gas) exits the shroud 302 and/or the thermal sensor calibration device 102 via an exhaust 508. In some such examples, moisture is removed with the exhausted cryogenic fluid in gaseous form. In some other examples, the cryogenic fluid exiting from the shroud 302 is returned to the liquid chiller 108.

To control and/or regulate a temperature of the blackbody target 306, the liquid chiller 108 is provided with cryogenic fluid from the cryogenic fluid storage 110, which is implemented as a liquid nitrogen dewar in this example. In turn, the example liquid chiller 108 controls and/or regulates a temperature of the heat transfer fluid circulated to the blackbody target 306 via fluid lines 510a, 510b, which can be implemented as the fluid lines 112 of FIGS. 1-4. In this example, one of the fluid lines 510a, 510b provides heat transfer fluid (e.g., coolant fluid) to be circulated within the blackbody target 306 and another of the fluid lines 510a 510b acts as a return to remove the heat transfer fluid from the blackbody target 306 and return the removed heat transfer fluid to the liquid chiller 108. In this example, at least one sensor (e.g., at least one thermocouple sensors) 512 is/are attached to and/or disposed within the thermal sensor calibration device 102. In this example, the sensor(s) 512 is/are attached to the blackbody target 306 and/or the shroud 302. In some other examples, the aforementioned thermocouple display/interface 502 is utilized to display temperature measurements from the sensor(s) 512 and/or forward the temperature measurements for control of the liquid chiller 108.

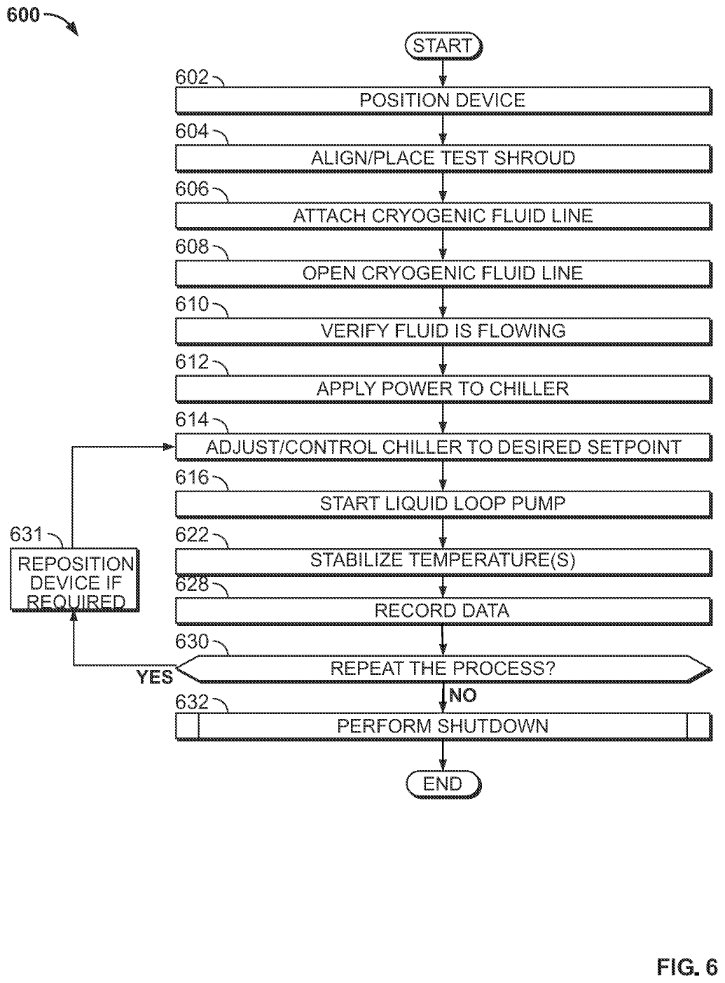

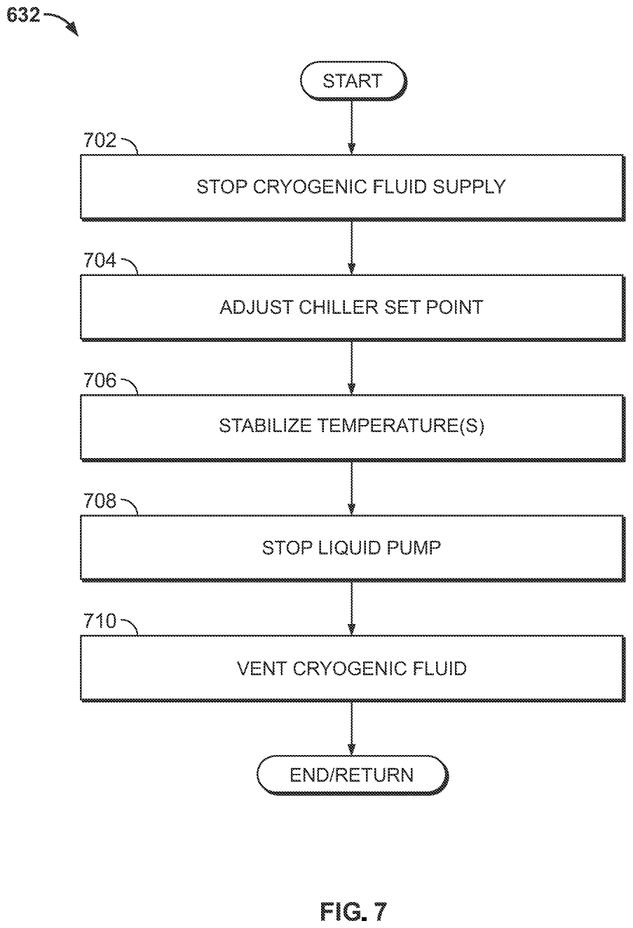

FIGS. 6 and 7 are flowcharts representative of an example method 600 in accordance with teachings of this disclosure. Turning to FIG. 6, the example method 600 begins at block 602 at which the thermal sensor calibration device 102 is positioned and/or placed proximate (e.g., onto) a thermal sensor for calibration thereof. In particular, the thermal sensor calibration device 102 is placed proximate the thermal sensor such that an entirety of a field of view of the thermal sensor is covered and/or filled by the thermal sensor calibration device 102. In some examples, the thermal sensor calibration device 102 is placed such that a portion of the thermal sensor calibration device 102 contacts an indexing and/or guiding surface of the thermal sensor or a component surrounding and/or supporting the thermal sensor.

At block 604, in some examples, the shroud 302 of the thermal sensor calibration device 102 is aligned/placed (e.g., to aim the thermal sensor toward the blackbody target 306).

At block 606, the cryogenic fluid line from the cryogenic fluid storage 110 is attached/coupled (e.g., releasably coupled) to the liquid chiller 108.

At block 608, the cryogenic fluid line between the cryogenic fluid storage 110 and the liquid chiller 108 is opened, thereby enabling the cryogenic fluid to flow therebetween. For example, a valve of the cryogenic fluid line between the cryogenic fluid storage 110 and the liquid chiller 108 is moved to an open and/or partially open position. Additionally or alternatively, a valve positioned on the cryogenic fluid storage 110 is opened.

At block 610, in some examples, it is verified and/or checked as to whether fluid (e.g. cryogenic fluid) is flowing from the cryogenic fluid storage 110 to the liquid chiller 108.

At block 612, the example liquid chiller 108 is provided with power and/or turned on.

At block 614, according to examples disclosed herein, a setpoint of the liquid chiller 108 is adjusted and/or set to a desired temperature.

At block 616, a liquid loop pump associated with the liquid chiller 108 is initiated/started (if not started) to cool or heat and control a temperature of the blackbody target 306.

At block 622, the temperature of the heat transfer fluid provided to the thermal sensor calibration device 102 and/or a temperature associated with the thermal sensor calibration device 102 is stabilized based on the liquid chiller 108 being adjusted and/or controlled to the desired set point temperature.

At block 628, in this example, data with respect to calibration of the thermal sensor is recorded. For example, the data is utilized to generate calibration data of the thermal sensor.

At block 630, it is determined whether to repeat the process. If the process is to be repeated (block 630), control of the process returns to block 631. Otherwise, the process proceeds to block 632. The determination may be based on whether additional setpoints are to be tested and/or whether additional sensors are to be calibrated.

At block 631, the thermal sensor calibration 302 is repositioned and/or moved if required and the process returns to block 614. For example, the thermal sensor calibration device 102 is moved to capture a different data point and/or to calibrate an additional thermal sensor.

At block 632, a shutdown process corresponding to cessation of calibration of the thermal sensor is performed, as will be discussed in greater detail below in connection with FIG. 7, and the process ends.

FIG. 7 is a flowchart of the subprocess 632 shown in FIG. 6. The example subprocess 632 is implemented for shutting down and/or stopping a calibration process of a thermal sensor. At block 702, the cryogenic fluid storage 110 is stopped and/or prevented from further providing cryogenic fluid. In this example, a valve corresponding to the cryogenic fluid storage 110 is closed to cease further supply of the cryogenic fluid.

At block 704, in this example, a setpoint of the liquid chiller 108 is set to an ambient temperature (e.g., an ambient room temperature, a vehicle ambient temperature, an environmental ambient temperature, etc.).

At block 706, according to examples disclosed herein, the temperature of the heat transfer fluid provided to the thermal sensor calibration device 102 and/or a temperature associated with the thermal sensor calibration device 102 is stabilized to the ambient temperature.

At block 708, in this example, a pump associated with the liquid chiller 108 is stopped. In particular, the example liquid chiller 108 is prevented from providing and/or dispensing heat transfer fluid to the blackbody target 306.

At block 710, in some examples, cryogenic fluid is vented and the process ends/returns. In some examples, the cryogenic fluid is vented e.g., from a fluid line.

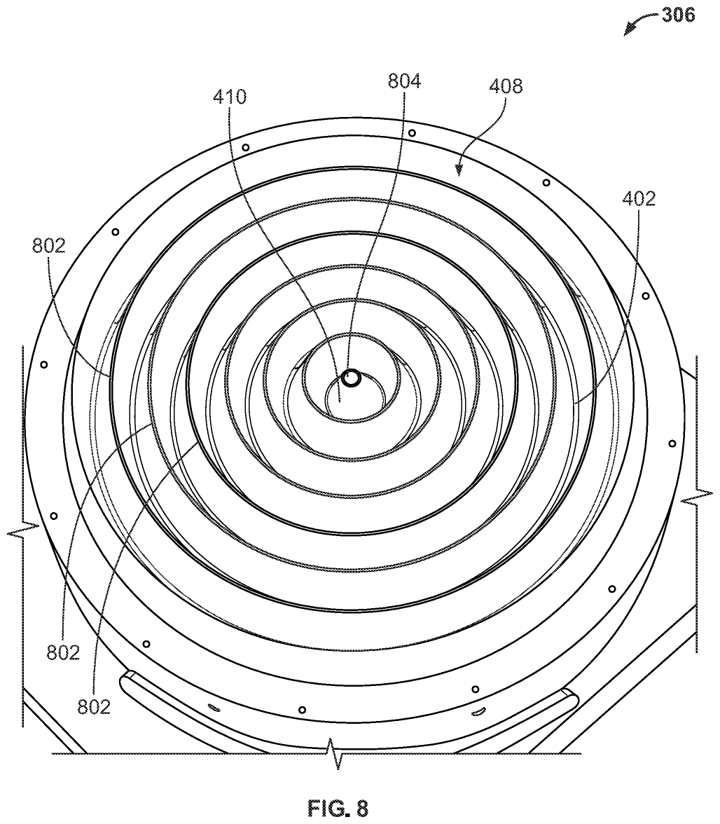

FIG. 8 is a detailed view of the example blackbody target 306 that can be implemented in examples disclosed herein. As can be seen in the illustrated example of FIG. 8, rings 802 of the ring pattern 408 are shown surrounding the center protrusion 410 which, in turn, includes a center converging center tip 804, which can be rounded or include a relatively sharp tip, for example. According to examples disclosed herein, the rings 802 have a generally converging shape as they extend away from the base 402 of the blackbody target 306. In some examples, ones of the rings 802 converge to a relatively sharp tip along a direction away from the base 402. The example geometry shown in FIG. 8 has been particularly effective in enabling a relatively uniform temperature for a thermal sensor calibration process.

In some examples, the rings 802 are evenly spaced apart. In other examples, the rings 802 are spaced apart at differing spacing intervals. In this example, the rings 802 generally extend at the same height from the base 402. However, in other examples, the rings 802 have different heights from the base 402. In the illustrated example, the ring pattern 408 surrounds (e.g., concentrically surrounds) the center protrusion 410. In some examples, complimentary/emissivity coatings can be applied to the black body target 306 to effectively increase an emissivity of a target face (e.g., as viewed by a thermal sensor being calibrated). In some examples, the blackbody target 306 includes and/or is at least partially composed of aluminum alloy and/or copper, etc. However, any other appropriate material can be implemented instead. The blackbody target 306 may be 3D printed, for example.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

Example methods, apparatus, systems, and articles of manufacture to enable accurate and convenient calibration of thermal sensors are disclosed herein. Further examples and combinations thereof include the following:

Example 1 includes an apparatus to calibrate a sensor, the apparatus comprising a shroud defining a sensor aperture and a chamber, a blackbody target disposed within the chamber, and a fluid inlet fluidly coupled to the blackbody target, the fluid inlet to receive heat transfer fluid for calibration of the sensor.

Example 2 includes the apparatus as defined in example 1, wherein the fluid inlet is a first fluid inlet, and further including a second fluid inlet of the shroud to receive cryogenic fluid, and a manifold to receive the cryogenic fluid to cool an internal surface of the shroud.

Example 3 includes the apparatus as defined in example 2, wherein the first fluid inlet is to be fluidly coupled to a liquid chiller, and wherein the second fluid inlet is fluidly coupled to a cryogenic fluid source.

Example 4 includes the apparatus as defined in any of examples 1 to 3, wherein the blackbody target includes nested spiral liquid loops for the heat transfer fluid to flow therethrough.

Example 5 includes the apparatus as defined in example 4, wherein the blackbody target includes a concentric pattern of rings on a surface to face the sensor.

Example 6 includes the apparatus as defined in any of examples 1 to 5, wherein the shroud has a converging shape with the sensor aperture at or proximate an apex of the shroud.

Example 7 includes the apparatus as defined in example 6, wherein the sensor aperture is to receive at least a portion of the sensor.

Example 8 includes the apparatus as defined in any of examples 6 or 7, wherein the shroud includes at least one of insulative material or an insulative layer.

Example 9 includes a system comprising a cryogenic fluid source, a chiller, and a sensor testing target including a shroud defining a sensor aperture and a chamber, the shroud including a fluid inlet fluidly coupled to the cryogenic fluid source to receive cryogenic fluid to cool an internal surface of the chamber, and a blackbody target disposed within the chamber, at least one internal channel of the blackbody target fluidly coupled to the chiller to receive heat transfer fluid therefrom.

Example 10 includes the system as defined in example 9, further including a support pole to mount the sensor testing target.

Example 11 includes the system as defined in any of examples 9 or 10, wherein the cryogenic fluid source is to provide the cryogenic fluid to the chiller.

Example 12 includes the system as defined in any of examples 9 to 11, wherein the shroud includes an indexing surface at a converging portion of the shroud, the indexing surface to contact a thermal sensor to be calibrated.

Example 13 includes the system as defined in any of examples 9 to 12, further including at least one temperature sensor mounted to one or more of the shroud, or the blackbody target.

Example 14 includes the system as defined in any of examples 9 to 13, wherein the heat transfer fluid includes cryogenic fluid.

Example 15 includes a method of calibrating a sensor, the method comprising aligning a shroud to the sensor to cause a blackbody target of the shroud to face the sensor, the shroud defining a sensor aperture and a chamber with the blackbody target disposed therein, providing cryogenic fluid to the shroud, and obtaining sensor measurements from the sensor for calibration thereof.

Example 16 includes the method as defined in example 15, wherein heat transfer fluid is provided from a chiller to the blackbody target.

Example 17 includes the method as defined in example 16, wherein the heat transfer fluid is provided to double reversing nested spiral loops of the blackbody target.

Example 18 includes the method as defined in any of examples 16 or 17, further including measuring, via at least one thermocouple, temperatures of the shroud and the blackbody target.

Example 19 includes the method as defined in any of examples 16 to 18, further including providing cryogenic fluid to the chiller.

Example 20 includes the method as defined in any of examples 15 to 19, wherein the shroud is aligned to the sensor by pressing an indexing surface of the shroud against a surface laterally surrounding the sensor.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus to calibrate a sensor, the apparatus comprising:
a shroud defining a sensor aperture and a chamber:
a blackbody target disposed within the chamber: and
a fluid inlet fluidly coupled to the blackbody target, the fluid inlet to receive heat transfer fluid for calibration of the sensor.

2. The apparatus as defined in claim 1, wherein the fluid inlet is a first fluid inlet, and further including:
a second fluid inlet of the shroud to receive cryogenic fluid: and
a manifold to receive the cryogenic fluid to cool an internal surface of the shroud.

3. The apparatus as defined in claim 2, wherein the first fluid inlet is to be fluidly coupled to a liquid chiller, and wherein the second fluid inlet is fluidly coupled to a cryogenic fluid source.

4. The apparatus as defined in claim 1, wherein the blackbody target includes nested spiral liquid loops for the heat transfer fluid to flow therethrough.

5. The apparatus as defined in claim 4, wherein the blackbody target includes a concentric pattern of rings on a surface to face the sensor.

6. The apparatus as defined in claim 1, wherein the shroud has a converging shape with the sensor aperture at or proximate an apex of the shroud.

7. The apparatus as defined in claim 6, wherein the sensor aperture is to receive at least a portion of the sensor.

8. The apparatus as defined in claim 6, wherein the shroud includes at least one of insulative material or an insulative layer.

9. A system comprising:
a cryogenic fluid source;
a chiller; and
a sensor testing target including:
a shroud defining a sensor aperture and a chamber, the shroud including a fluid inlet fluidly coupled to the cryogenic fluid source to receive cryogenic fluid to cool an internal surface of the chamber, and
a blackbody target disposed within the chamber, at least one internal channel of the blackbody target fluidly coupled to the chiller to receive heat transfer fluid therefrom.

10. The system as defined in claim 9, further including a support pole to mount the sensor testing target.

11. The system as defined in claim 9, wherein the cryogenic fluid source is to provide the cryogenic fluid to the chiller.

12. The system as defined in claim 9, wherein the shroud includes an indexing surface at a converging portion of the shroud, the indexing surface to contact a thermal sensor to be calibrated.

13. The system as defined in claim 9, further including at least one temperature sensor mounted to one or more of the shroud, or the blackbody target.

14. The system as defined in claim 9, wherein the heat transfer fluid includes cryogenic fluid.

15. A method of calibrating a sensor, the method comprising:
aligning a shroud to the sensor to cause a blackbody target of the shroud to face the sensor, the shroud defining a sensor aperture and a chamber with the blackbody target disposed therein;
providing cryogenic fluid to the shroud; and
obtaining sensor measurements from the sensor for calibration thereof.

16. The method as defined in claim 15, wherein heat transfer fluid is provided from a chiller to the blackbody target.

17. The method as defined in claim 16, wherein the heat transfer fluid is provided to double reversing nested spiral loops of the blackbody target.

18. The method as defined in claim 16, further including measuring, via at least one thermocouple, temperatures of the shroud and the blackbody target.

19. The method as defined in claim 16, further including providing cryogenic fluid to the chiller.

20. The method as defined in claim 15, wherein the shroud is aligned to the sensor by pressing an indexing surface of the shroud against a surface laterally surrounding the sensor.
